(19) United States
(12) Patent Application Publication
(10) Pub. No.: US 2008/0247642 A1
(43) Pub. Date: Oct. 9, 2008

(54) IMAGE PROCESSING APPARATUS AND IMAGE PROCESSING METHOD

(75) Inventor: Kimimori Eguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/099,413

(22) Filed: Apr. 8, 2008

(30) Foreign Application Priority Data
Apr. 9, 2007 (JP) 2007-101616

(51) Int. Cl. G06K 9/00

(52) U.S. Cl. 382/167

(57) ABSTRACT

In conventional technology, it is likely that good image quality cannot be obtained because various image processing such as color processing or halftone processing (dithering processing and error diffusion processing, for example) which differs from desired processing is executed in the trapping processing or black overprint processing. The present invention has an object of obtaining desire good image quality in the trapping processing or black overprint processing, and is characterized by having a means for or a step of generating attribute information for each color plate before or during the image transforming processing.

### BACKGROUND OF THE INVENTION

1. Field of the Invention

The present invention relates to an image processing apparatus and image processing method capable of improving image quality in a trap portion (portion subjected to trapping processing) or in an overprint portion (portion subjected to black overprint processing).

2. Description of Related Art

FIG. 4 shows an example of an image processing sequence. Image data (such as PDL code) expressed in terms of a command group received by a communication I/F 401 is converted to an intermediate code by an interpreter 402. Subsequently, a Rip 403 renders the intermediate code to a bitmap. In this case, the Rip 403 outputs attribute information as well. After that, using the attribute data, an image transforming processing section 408 carries out image transforming processing such as trapping processing. In addition, using the attribute data, an image processing section 409 executes various image processing, and delivers the image-processed data to a printer 410.

Generally, an image forming apparatus such as a copying machine has a set of a plurality of different screens (such as a small line number screen, large line number screen and error diffusion screen). In the dithering processing by the image processing section 409 of FIG. 4, the set of screens are switched in accordance with the attribute information (such as using the small line number screen for graphics, and using the large line number screen for text and thin lines).

Thus switching the screen in accordance with the attribute information leads to the improvement of the image quality. Conventionally, in the processing that transforms areas for each plate such as trapping processing or black overprint processing, the information on pixel values of the image converted into bitmap using the attribute information is corrected. But, the attribute information is not corrected. Accordingly, as for the portion subjected to the trapping processing (i.e. the transformed areas), the image processing is executed in accordance with the attribute information of the other plate about the trap portion. That is, the screen for the other plate covers the trap portion. As a result, this leads to image quality degradation.

For example, as shown in FIG. 6A, a cyan (C) letter K has a text attribute and a magenta (M) background object has a graphics attribute. The trapping processing in the image processing section 409 of FIG. 4 results in FIG. 6B. FIG. 6B shows a situation after the image forming in which the letter K undergoes the trapping processing on the background object. It shows the situation in which the cyan plate image of the letter K gets into the background magenta plate image, and the cyan plate image and the magenta plate image overlap at the trap portion. Cross sections of the trap portion become as shown in FIGS. 6(C) and 6(D) (the overlapped plate portion resulting from the trapping processing is referred to as “trap portion” in this specification).

When the image processing section 409 performs the dithering processing on the trap portion of FIG. 6B which undergoes the foregoing trapping processing, the trap portion becomes like a portion designated by the reference numeral 601 of FIG. 6F. In the portion 601, although the letter K is covered with the large line number screen because it has the text attribute, the cyan plate trap portion is covered with the small line number screen because it has the graphics attribute.

Originally, as shown in the portion 602 of FIG. 6G, the trap portion of the cyan plate has the text attribute, which is to be covered with the large line number screen. In contrast, the magenta plate, which has the graphics attribute, should be covered with the small line number screen. However, since the attribute cannot be switched exactly from plate to plate, the trap portion is not covered with a desired screen as in the foregoing example, resulting in the image quality degradation.

On the other hand, from the view point of rewriting the attribute, Japanese Patent Laid-Open No. 2001-358929 discloses a method of overwriting the attribute at the image combining. This method, however, does not maintain the attribute for each plate, but preserves a single attribute for each pixel regardless of the plate.

As described above, as for the attribute information used in the trapping processing or black overprint processing, the handling of the attribute has not been studied sufficiently. Thus, in the trapping processing or black overprint processing, various image processing is executed such as color processing or halftone processing (dithering processing and error diffusion processing, for example) which differs from desired processing. Accordingly, it is likely that satisfactory image quality cannot be achieved.

### SUMMARY OF THE INVENTION

To solve the foregoing problems, the present invention is characterized by having a means for or a step of generating the attribute information of each color plate before or during the image transforming processing, and has the following configuration concretely.

In the first aspect of the present invention, there is provided an image processing apparatus comprising: input means for inputting image data represented in a command group associated with each object constituting an image; interpreting means for interpreting the command group to convert into intermediate code; attribute plate dividing means for dividing attribute information contained in the command group for each of specified color plates of color plates corresponding to a plurality of color materials; means for bitmapping the intermediate code for each color plate; image transforming means for transforming, in accordance with the attribute information, an area of a bitmapped specific object for each color plate; attribute rewriting means for rewriting an attribute in the attribute information according to a result of transforming processing by said image transforming means; and image processing means for executing image processing using the rewritten attribute information.

In the second aspect of the present invention, there is provided an image processing apparatus comprising: input means for inputting image data represented in a command group associated with each object constituting an image; interpreting means for interpreting the command group to convert into intermediate code; attribute plate dividing means for dividing attribute information contained in the command group for each of specified color plates of color plates corresponding to a plurality of color materials; image transforming means for transforming, in accordance with the attribute information, an area of a specific object in the intermediate code for each color plate; attribute rewriting means for rewriting an attribute in the attribute information according to a result of transforming processing by said image transforming means; means for bitmapping the intermediate code for each color plate; and image processing means for executing image processing in accordance with the attribute information of each color plate.

In the third aspect of the present invention, there is provided an image processing apparatus comprising: input means for inputting image data represented in a command group associated with each object constituting an image; interpreting means for interpreting the command group to perform bitmapping for each of color plates corresponding to a plurality of color materials; attribute information generating means for developing attribute information contained in the command group; image transforming means for transforming for each color plate an area of a bitmapped object in accordance with the attribute information; attribute generating means for generating the attribute information for each specified color plate according to a result of transforming processing by said image transforming means; and image processing means for executing image processing in accordance with the attribute information of each color plate.

In the fourth aspect of the present invention, there is provided an image processing apparatus comprising: input means for inputting image data represented in a command group associated with each object constituting an image; interpreting means for interpreting the command group to convert into intermediate code; attribute information generating means for developing attribute information contained in the command group; image transforming means for transforming an area of a specific object in the intermediate code for each of color plates corresponding to a plurality of color materials; attribute generating means for generating the attribute information of each color plate according to a result of transforming processing by said image transforming means; means for bitmapping the intermediate code for each color plate; and image processing means for executing image processing in accordance with the attribute information of each color plate.

In the fifth aspect of the present invention, there is provided an image processing apparatus comprising: input means for inputting image data represented in a command group associated with each object constituting an image; interpreting means for interpreting the command group to convert into intermediate code; attribute plate dividing means for dividing attribute information contained in the command group for each of specified color plates of color plates corresponding to a plurality of color materials; first image transforming means for transforming an area of a specific object in the intermediate code for each color plate in accordance with the attribute information; first attribute rewriting means for rewriting the attribute information according to a result of transforming processing by said first image transforming means; means for bitmapping the intermediate code for each color plate; second image transforming means for identifying an area of an object without the transforming among the objects according to the attribute information of each color plate rewritten by said first attribute rewriting means, and for transforming for each color plate a portion requiring transformation in the area of the object identified; second attribute rewriting means for further rewriting, according to a result of the transforming processing by said second image transforming means, the attribute information of each color plate rewritten by said first attribute rewriting means; and image processing means for executing image processing according to the attribute information of each color plate rewritten by said second attribute rewriting means.

In the sixth aspect of the present invention, there is provided an image processing apparatus comprising: reading means for reading a original document and outputting color image data; generating means for generating flag data for indicating a feature of an image according to the color image data; flag data plate dividing means for dividing the flag data for each of color plates corresponding to a plurality of color materials; image transforming means for transforming for each color plate a specific characteristic area of the image according to the flag data; flag data rewriting means for rewriting the flag data of each color plate according to a result of the transforming processing by said image transforming means; and image processing means for executing image processing according to the rewritten flag data.

In the seventh aspect of the present invention, there is provided an image processing method comprising: a step of inputting image data represented in a command group associated with each object constituting an image; a step of interpreting the command group to convert into intermediate code; a step of dividing attribute information contained in the command group for each of specified color plates of color plates corresponding to a plurality of color materials; a step of bitmapping the intermediate code for each color plate; a step of transforming, in accordance with the attribute information, an area of a bitmapped specific object for each color plate; a step of rewriting an attribute in the attribute information according to a result of transforming processing by said step of transforming; and a step of executing image processing using the rewritten attribute information.

In the eighth aspect of the present invention, there is provided an image processing method comprising: a step of inputting image data represented in a command group associated with each object constituting an image; a step of interpreting the command group to convert into intermediate code; a step of dividing attribute information contained in the command group for each of specified color plates of color plates corresponding to a plurality of color materials; a step of transforming, in accordance with the attribute information, an area of a specific object in the intermediate code for each color plate; a step of rewriting an attribute in the attribute information according to a result of transforming processing by said step of transforming; a step of bitmapping the intermediate code for each color plate; and a step of executing image processing in accordance with the attribute information of each color plate.

In the ninth aspect of the present invention, there is provided an image processing method comprising: a step of inputting image data represented in a command group associated with each object constituting an image; a step of interpreting the command group to perform bitmapping for each of color plates corresponding to a plurality of color materials; a step of developing attribute information contained in the command group; a step of transforming for each color plate an area of a bitmapped object in accordance with the attribute information; a step of generating the attribute information for each specified color plate according to a result of transforming processing by said step of transforming; and a step of executing image processing in accordance with the attribute information of each color plate.

In the tenth aspect of the present invention, there is provided an image processing method comprising: a step of inputting image data represented in a command group associated with each object constituting an image; a step of interpreting the command group to convert into intermediate code; a step of developing attribute information contained in the command group; a step of transforming an area of a specific object in the intermediate code for each of color plates corresponding to a plurality of color materials; a step of generating the attribute information of each color plate according to a result of transforming processing by said step of transforming; a step of bitmapping the intermediate code for each color plate; and a step of executing image processing in accordance with the attribute information of each color plate.

In the eleventh aspect of the present invention, there is provided an image processing method comprising: a step of inputting image data represented in a command group associated with each object constituting an image; a step of interpreting the command group to convert into intermediate code; a step of dividing attribute information contained in the command group for each of specified color plates of color plates corresponding to a plurality of color materials; a first image transform step of transforming an area of a specific object in the intermediate code for each color plate in accordance with the attribute information; a first attribute rewriting step of rewriting the attribute information according to a result of transforming processing by said first image transform step; a step of bitmapping the intermediate code for each color plate; a second image transform step of identifying an area of an object without the transforming among the objects according to the attribute information of each color plate rewritten by said first attribute rewriting step, and of transforming for each color plate a portion requiring transformation in the area of the object identified; a second attribute rewriting step of further rewriting, according to a result of the transforming processing by said second image transform step, the attribute information of each color plate rewritten by said first attribute rewriting step; an image processing step of executing image processing according to the attribute information of each color plate rewritten by said second attribute rewriting step.

In the twelfth aspect of the present invention, there is provided an image processing method comprising: a step of reading a original document and outputting color image data; a step of generating flag data for indicating a feature of an image according to the color image data; a step of dividing the flag data for each of color plates corresponding to a plurality of color materials; a step of transforming for each color plate a specific characteristic area of the image according to the flag data; a step of rewriting the flag data of each color plate according to a result of the transforming processing by said step of transforming; and a step of executing image processing according to the rewritten flag data.

According to the present invention, the attribute information can be maintained for each plate in the image processing, such as the trapping processing or black overprint processing, that transforms areas of individual plates of a plurality of color materials. This makes it possible to execute the image processing such as color processing or dithering processing which differs for each plate after the trapping processing or black overprint processing. As a result, the image quality can be improved in a trap portion (portion subjected to the trapping processing) or in an overprint portion (portion subjected to the black overprint processing).

In addition, the present invention is effective not only for the image processing that transforms areas of individual areas such as trapping processing or black overprint processing carried out before converting the image into bitmap, but also for image processing that transforms the areas of individual areas carried out after converting the image into bitmap.

Further features of the present invention will become apparent from the following description of exemplary embodiments (with reference to the attached drawings).

### BRIEF DESCRIPTION OF THE DRAWINGS

FIG. 1 is a block diagram showing a general configuration of an image forming apparatus 100 of an embodiment in accordance with the present invention;

FIGS. 2A to 2B are block diagrams showing a part of an image processing section of the image forming apparatus of a first embodiment in accordance with the present invention;

FIG. 3A is a schematic diagram of the image forming apparatus of a first example of the first embodiment;

FIG. 3B is a schematic diagram of the image forming apparatus of a second example of the first embodiment;

FIG. 3C is a schematic diagram of the image forming apparatus of a third example of the first embodiment;

FIG. 3D is a schematic diagram of the image forming apparatus of a fourth example of the first embodiment;

FIG. 4 is a schematic diagram of a conventional image forming apparatus;

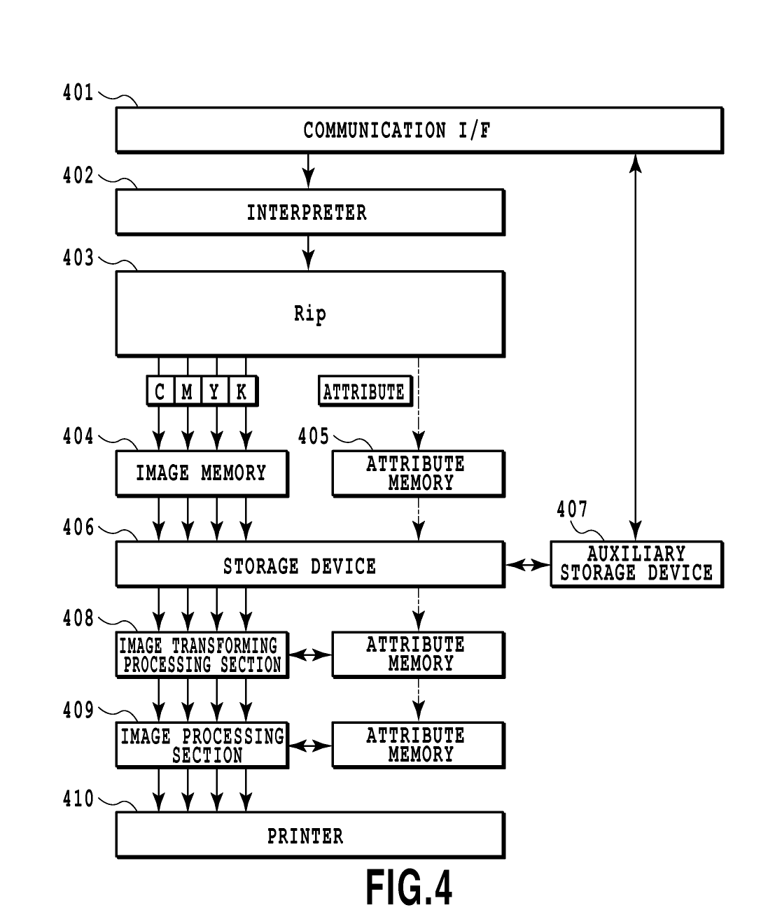

FIG. 5 is a schematic diagram of the image forming apparatus of a third embodiment in accordance with the present invention;

FIGS. 6A to 6G are diagrams illustrating trapping processing in each example of the first embodiment in accordance with the present invention, and particularly 6C and 6D are cross sectional views of a trap portion;

FIGS. 7A to 7H are diagrams illustrating black overprint processing in each example of the first embodiment in accordance with the present invention;

FIG. 8A is a diagram for explaining attribute information in the trapping processing in the first example of the first embodiment;

FIG. 8B is a diagram for explaining the attribute information in the trapping processing in a second embodiment in accordance with the present invention;

FIGS. 9A to 9B are diagrams for explaining a case where trapping processing is unnecessary; and

FIG. 10 is a diagram showing a hardware configuration of an image forming apparatus 100 of an embodiment in accordance with the present invention.

### BRIEF DESCRIPTION OF THE EMBODIMENTS

The image processing in the image forming apparatus of an embodiment in accordance with the present invention will now be described in detail with reference to the accompanying drawings.

### First Embodiment

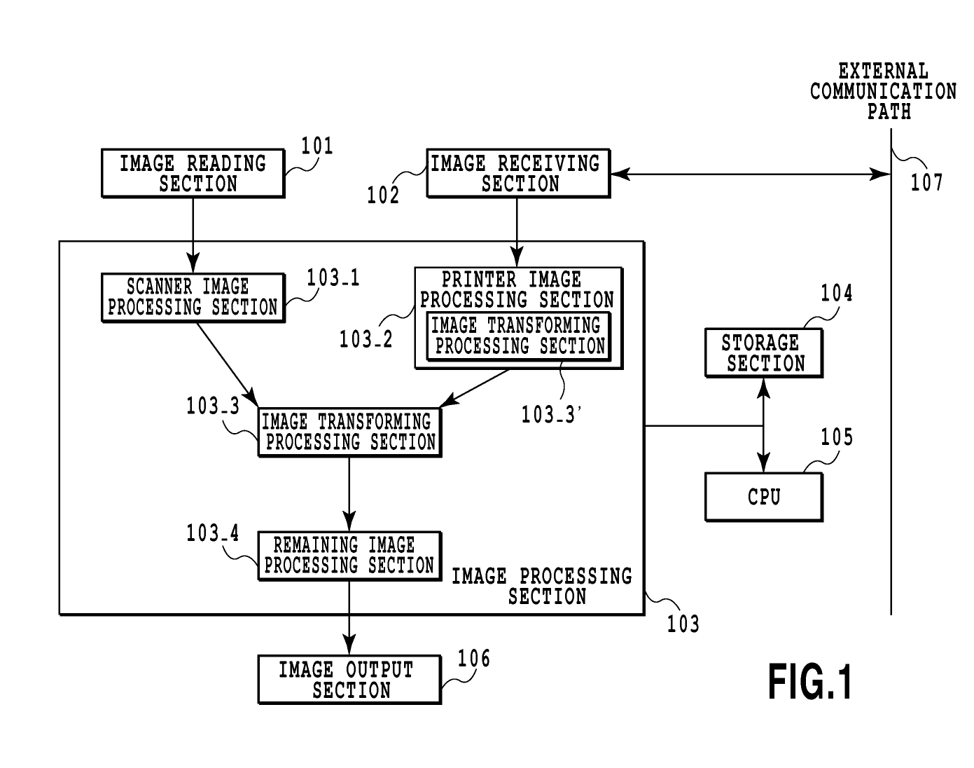

FIG. 1 is a general block diagram of the image forming apparatus of a first embodiment in accordance with the present invention. Although the present embodiment supposes a digital multifunction machine as an image forming apparatus, it is applicable not only to a copying machine, but also to other printing devices such as a color printer.

First, a configuration of the image forming apparatus of the present embodiment will be described.

As shown in FIG. 1, the image forming apparatus has an image reading section 101, an image receiving section 102, an image processing section 103 for carrying out various image processing, a storage section 104, a CPU 105 and an image output section 106. The image forming apparatus is also connectable to a server that manages image data or to a personal computer (PC) that instructs the image forming apparatus to carry out printing via a network such as a LAN and the Internet. In addition, it is connectable to an external communication path 107 via the image receiving section 102.

Next, the operation of each component of the image forming apparatus shown in FIG. 1 will be described.

The image reading section 101 reads an input image. For example, the image reading section 101 reads an RGB color image and the like. Subsequently, the read RGB data is sent to the image processing section 103. A scanner image processing section 103_1 for an image read performs image processing such as shading correction, image region separating processing and color conversion on the color signals of the RGB data.

On the other hand, the PDL image data input to the image receiving section 102 is sent to the image processing section 103. Not only the PDL image data, but also any image data can be used which is expressed by a command group associated with each object constituting the image. First, the interpreter of a printer image processing section 103_2 construes the command group of the PDL image data, and outputs intermediate code. Subsequently, the Rip (Raster image processor) of the printer image processing section 103_2 develops the intermediate code to a bitmap image. At the same time, the attribute information contained in the command group is developed to the attribute information on each pixel (such as a graphics attribute, color attribute, natural image attribute, text attribute, and thin line attribute).

Subsequently, an image transforming processing section 103_3 receives the data from the image reading section 101 or from the image receiving section 102, and carries out processing of transforming an object, or different processing for each color plate. Here, as the processing of transforming the object, processing such as trapping processing and black overprint processing is performed. Lastly, a remaining image processing section 103_4 performs prescribed color processing, dithering processing and the like.

Next, the configuration and operation of the storage section 104, CPU 105 and image output section 106 of the image forming apparatus as shown in FIG. 1 will be described.

The storage section 104 comprises various types of storage mediums such as a random access memory (RAM) and read only memory (ROM). For example, the RAM is used as an area for storing data and various pieces of information, or as workspace of the CPU 105. On the other hand, the ROM is used as an area for storing various control programs. In addition, the CPU 105 is used for deciding and controlling various processings in accordance with the programs stored in the ROM. The image output section 106 serves to output an image (such as to form an image on a recording medium like printing paper and output it).

Generally, the processing different from plate to plate such as the trapping processing and black overprint processing is performs in two ways: On the data about the object within the Rip; and on the bitmap after rendering. The present embodiment is applicable to whichever case.

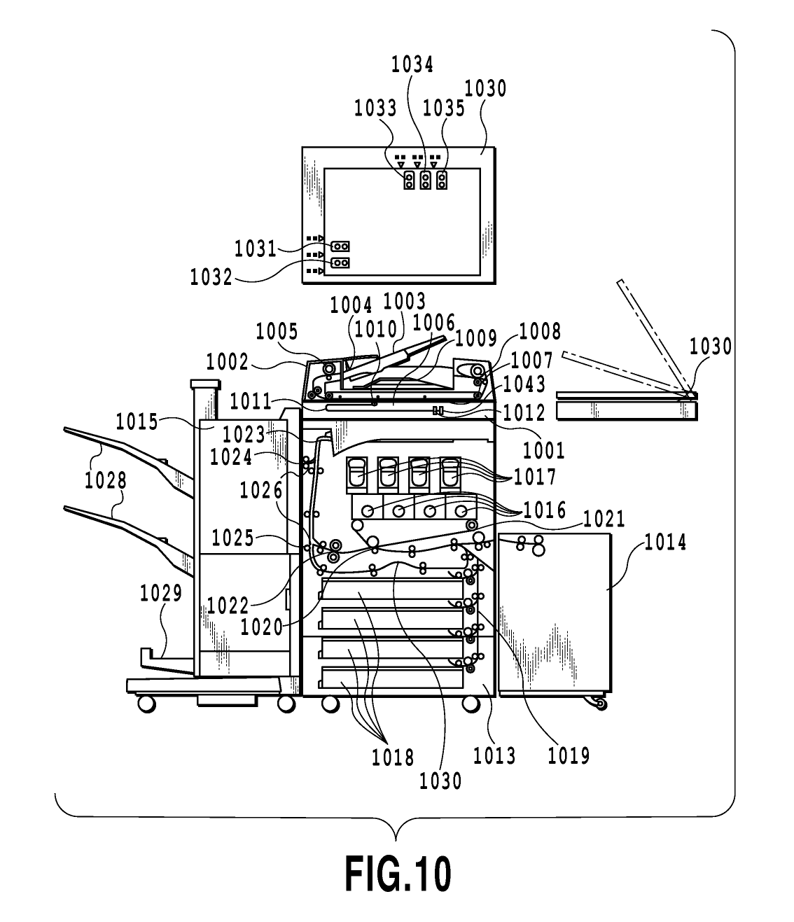

FIG. 10 is a diagram schematically showing a hardware configuration of the image reading section 101, image receiving section 102 and image output section 106 of the image forming apparatus in FIG. 1, which shows a cross sectional view of the image forming apparatus. Referring to FIG. 10, a detailed description will be made below of the image forming apparatus that is explained above with reference to FIG. 1.

The image forming apparatus has all the functions of a copier, printer and fax. In FIG. 10, the image forming apparatus of the present embodiment has a scanner 1001, a document feeder (DF) 1002, a printer 1013 having four color drums for print recording, a paper feed deck 1014, a finisher 1015 and the like.

First, reading operation primarily carried out by the scanner 1001 will be described.

To read an original document by setting it on a platen 1007, a user places the original document on the platen 1007 and closes the DF 1002. Then, after the open and close sensor 1030 detects that the platen 1007 is closed, light-reflecting type document size detecting sensors 1031-1035 in the casing of the scanner 1001 detect the original document size. Using the size detection as the start point, a light source 1010 illuminates the original document, and a CCD (charge-coupled device) 1043 reads the image by receiving reflected light from the original document via a reflective plate 1011 and a lens 1012.

Then, the controller of the image forming apparatus converts the image data read by the CCD 1043 to a digital signal, and converts it to a laser recording signal through desired image processing. The recording signal subjected to the conversion is stored in a memory within the controller.

In the case of reading an original document set on the DF 1002, the user places the original document on the tray of a document setting section 1003 of the DF 1002 with its face up. Then, a document sensor 1004 detects that the original document is placed. In response to it, a document feeder roller 1005 and a conveyor belt 1006 rotate to carry the original document. Thus, the original document is set at a prescribed position on the platen 1007. After that, the image is read in the same manner as in the case of reading via the platen 1007, and the recording signal obtained is stored in the memory within the controller.

When the reading completes, the conveyor belt 1006 starts rotating again to convey the original document toward the right side in the cross section of the image forming apparatus of FIG. 10, thereby ejecting the original document to a document output tray 1009 via a conveyor roller 1008 on the paper output side. If a plurality of original documents are present, at the same time when the original document is conveyed from the platen 1007 to the right side in the cross section of the image forming apparatus to be ejected, the next original document is conveyed from the left side in the cross section of the image forming apparatus via the document feeder roller 1005 so that the reading of the next original document is carried out continuously. The above is the operation of the scanner 1001.

Next, printing operation primarily carried out by the printer 1013 will be described.

The recording signal (print image data) temporarily stored in the memory within the controller is transferred to the printer 1013, and is converted to 4-color recording laser beams of yellow, magenta, cyan and black through a laser recording section. Then, the recording laser beams are irradiated on photosensitive materials 1016 of the individual colors, and form electrostatic latent images on the photosensitive materials.

The printer 1013 performs toner development on the photosensitive materials using toners supplied from toner cartridges 1017. The toner images visualized on the individual photosensitive materials undergo primary transfer on an intermediate transfer belt 1021. The intermediate transfer belt 1021 rotates clockwise in FIG. 10. At the time when recording paper conveyed from a paper cassette 1018 or a paper feed deck 1014 arrives at a secondary transfer position 1020 through a paper conveyor path 1019, the toner images are transferred from the intermediate transfer belt 1021 to the recording paper.

The recording paper to which the image is transferred is subjected to fixing of the toner by pressure and heating with a fixing device 1022. After that, the recording paper is conveyed through a paper output conveyor path to be ejected to a center tray 1023 facedown, to a paper output slit 1024 leading to the finisher after a switchback, or to a side tray 1025 faceup. The side tray 1025, however, is a paper output slit that enables the paper output only when the finisher 1015 is not installed. Flappers 1026 and 1027 are provided for switching the conveyor path to switch these paper output slits. To carry out double-sided printing, after the recording paper is carried through the fixing device 1022, the flapper 1027 switches the conveyor path. After that, the recording paper is switched back downward, passes through a double-sided printing paper conveyor path 1030, and is conveyed to the secondary transfer position 1020 again. Thus, the double-sided printing is performed.

Next, the operation of the finisher 1015 will be described.

The finisher 1015 adds post-processing to print-completed paper in accordance with a function designated by the user. More specifically, it has such functions as a staple (such as one spot binding and two spot binding), a punch (such as two hole punch and three hole punch), and a saddle stitch. The image forming apparatus of FIG. 10 has two output trays 1028, and the recording paper passing through the paper output slit 1024 to the finisher 1015 is sorted into one of the output trays 1028 depending on the functions of copying/printer/FAX, for example, in accordance with the user setting.

Although a print engine 1013 is a printer with 4-color drums, it goes without saying that it may be an engine with a 1-color drum, or a printer engine for a black-and-white recording. As for the image forming apparatus of FIG. 10, when it is used as a printer, various settings, such as black-and-white print/color print, paper size, 2-UP print/4-UP print/N-UP print, double side, staple, punch, saddle stitch binding, lamination, cover and back cover, are possible by a driver.

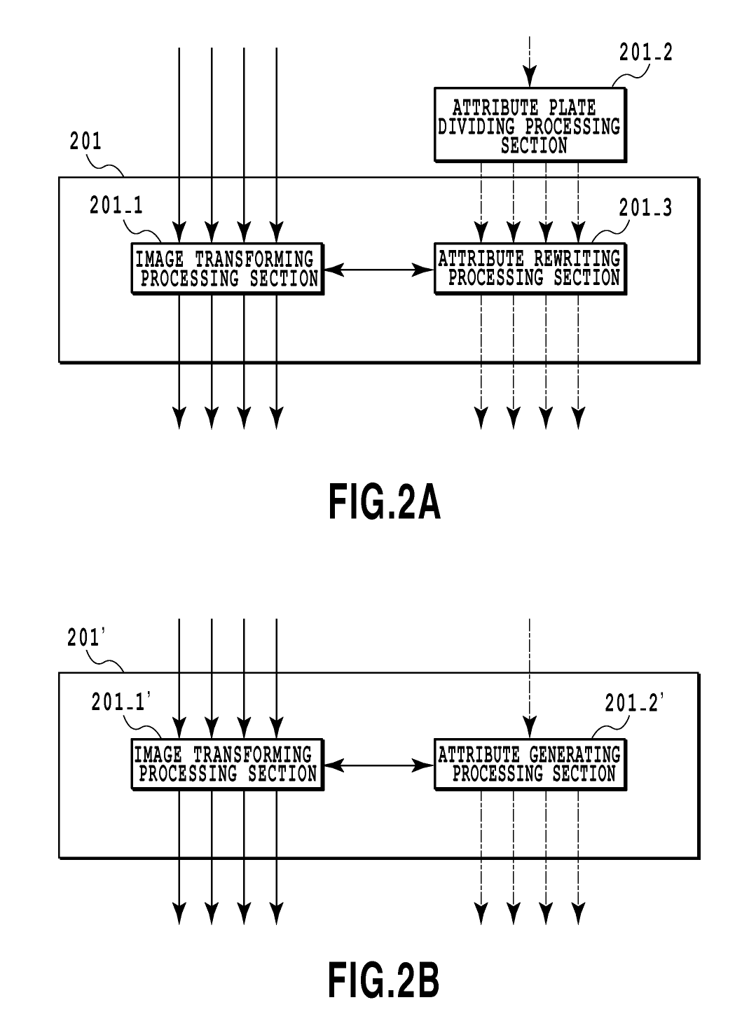

Next, referring to FIGS. 2A and 2B, an attribute information plate dividing method will be described together with a concrete processing procedure at the time when carrying out the trapping processing and dithering processing.

As for the image transforming processing and the attribute plate dividing processing, two aspects are conceivable: an aspect 201 of FIG. 2A; and an aspect 201′ of FIG. 2B. In addition, for each aspect, a case is assumed which is carried out by the image transforming processing section 103_3 or by the image transforming processing section 103_3′ of FIG. 1.

In FIG. 2A, an attribute plate dividing processing section 201_2 assigns the same attribute to all the plates as the attribute information about each pixel. Then, according to the processing result of an image transforming processing section 201_1, an attribute rewriting processing section 201_3 rewrites the plate divided attribute information (the detail will be described later). On the other hand, in FIG. 2B, according to the transforming processing result of an image transforming processing section 201_1′, an attribute generating section 201_2′ retouches the attribute information not subjected to the plate dividing and divides its plate, thereby generating the attribute information of each color plate.

### First Example

Here, as a first example of the present embodiment, the case will be described in which the image transforming processing of the image transforming processing section 103_3 is carried out in the form of the image transforming processing section 201_1 as shown in FIG. 2A. In this case, the processing of the image transforming processing section 103_3′ is not carried out.

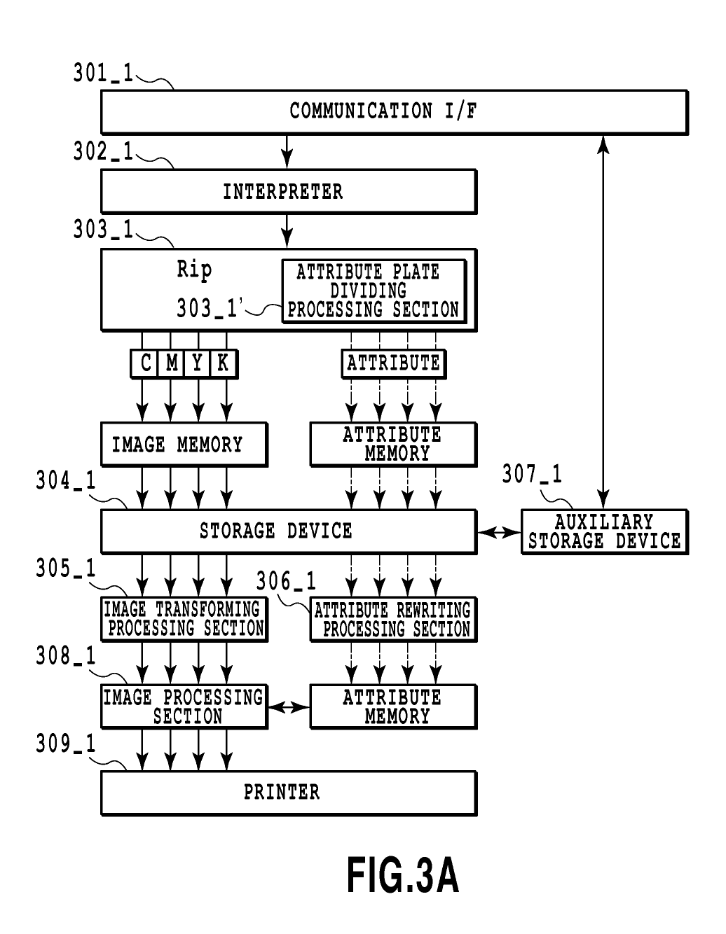

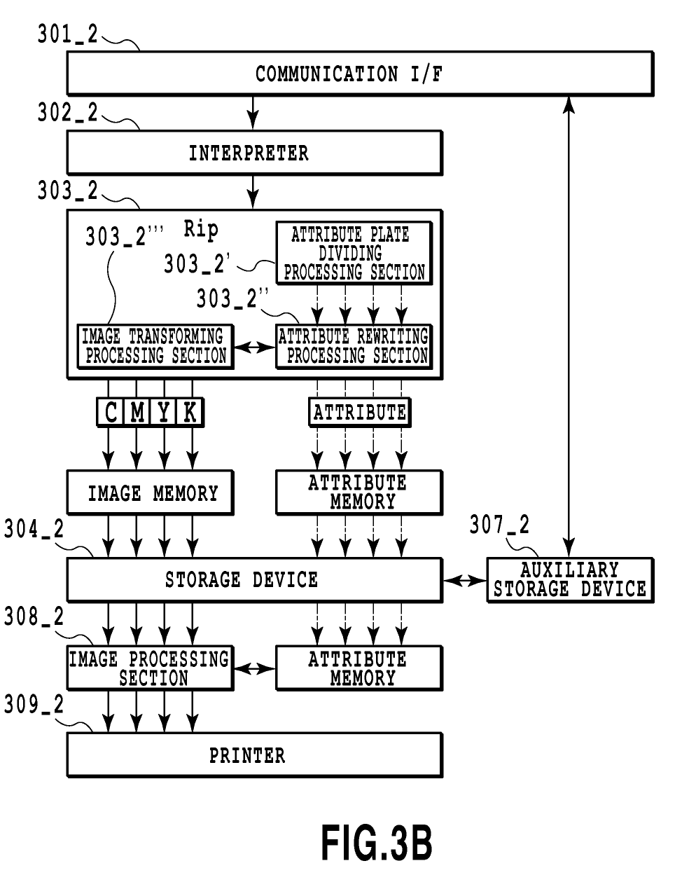

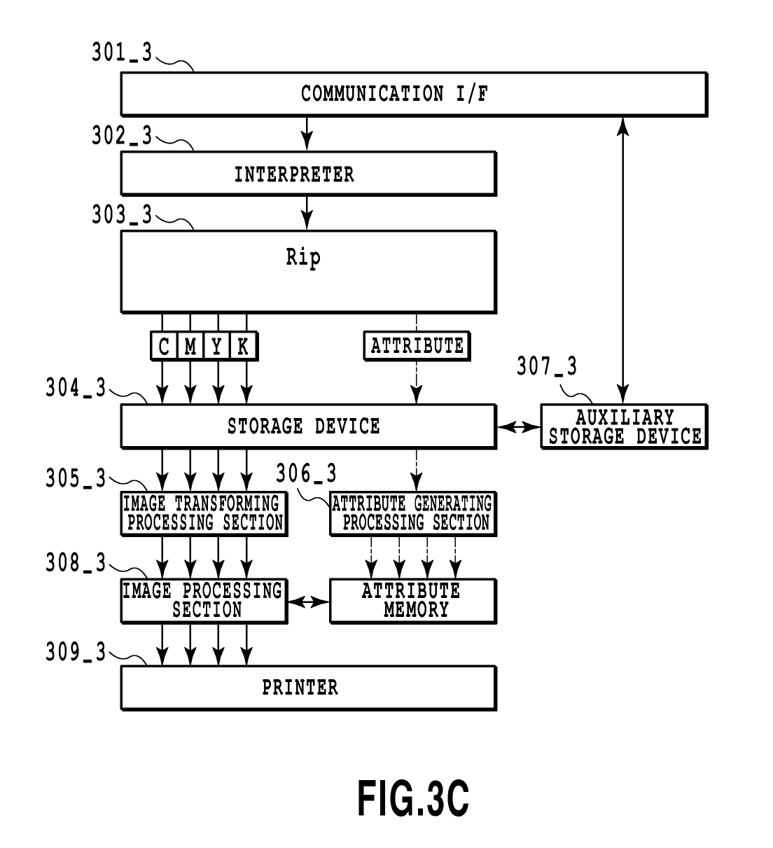

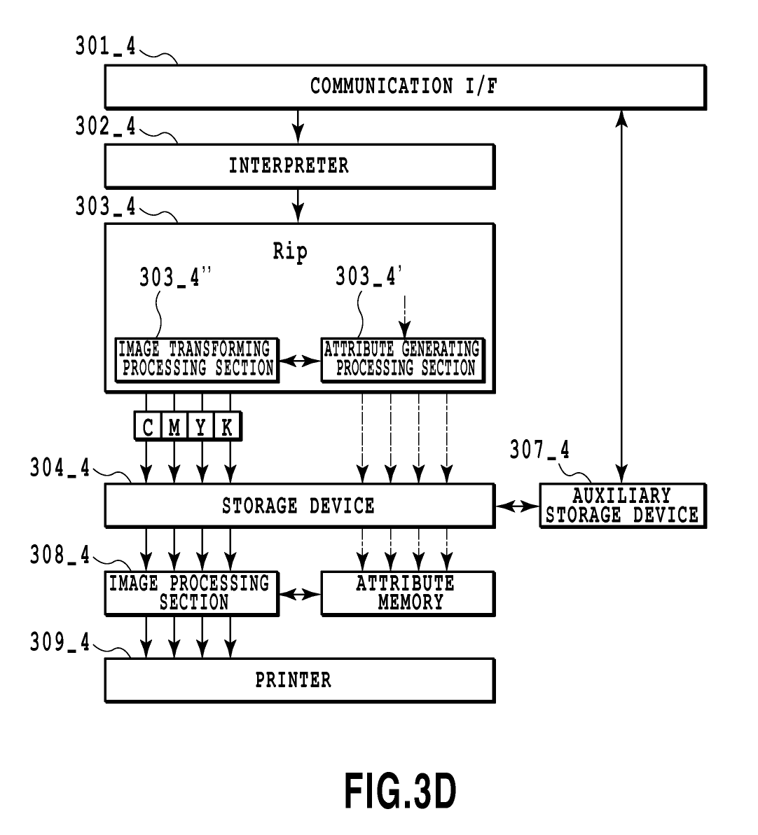

As shown in FIG. 3A, a communication interface (communication I/F) 301_1 receives a command group, first. The received command group is sent to an interpreter 302_1, which interprets it and converts to the intermediate code.

In addition, the Rip 303_1 converts the intermediate code into bitmaps of the plates corresponding to a plurality of color materials. In this case, from the attribute information contained in the command group (for example, the attribute is described for each pixel in the PDL code) the attribute information for each pixel is developed.

Subsequently, the attribute plate dividing processing section 303_1′ in the Rip 303_1 generates the developed attribute information for each plate. For example, when the attribute information of a certain pixel is graphics, cyan plate: graphics, magenta plate: graphics, yellow plate: graphics, and black plate: graphics are generated.

Subsequently, in accordance with the foregoing attribute information, the image transforming processing section 305_1 executes the processing of transforming the object for each plate. At the same time, the attribute at a portion whose form is changed by the attribute rewriting processing section 306_1 is switched. Then, the image processing section 308_1 executes various image processing in accordance with the attribute information.

Here, a concrete example will be described about the image transforming processing section 305_1 of FIG. 3A.

According to the image information transferred to the image transforming processing section 305_1 of FIG. 3A and the attribute information delivered to the attribute rewriting processing section 306_1, various image processing such as trapping processing or black overprint processing, and the attribute rewriting processing are carried out. In the trapping processing, as for the trap portion on which the trapping processing of thickening the letter shape is performed in a particular color plate of a letter across the boundary at which the attribute changes (such as a boundary between the letter and its background), the attribute of the plate is rewritten at the portion on which the trapping processing is performed.

Likewise, in the black overprint processing, as for the overprint portion on which the black overprint processing is performed across the boundary at which the attribute changes, the attribute of the plate is rewritten at the portion on which the black overprint processing is performed.

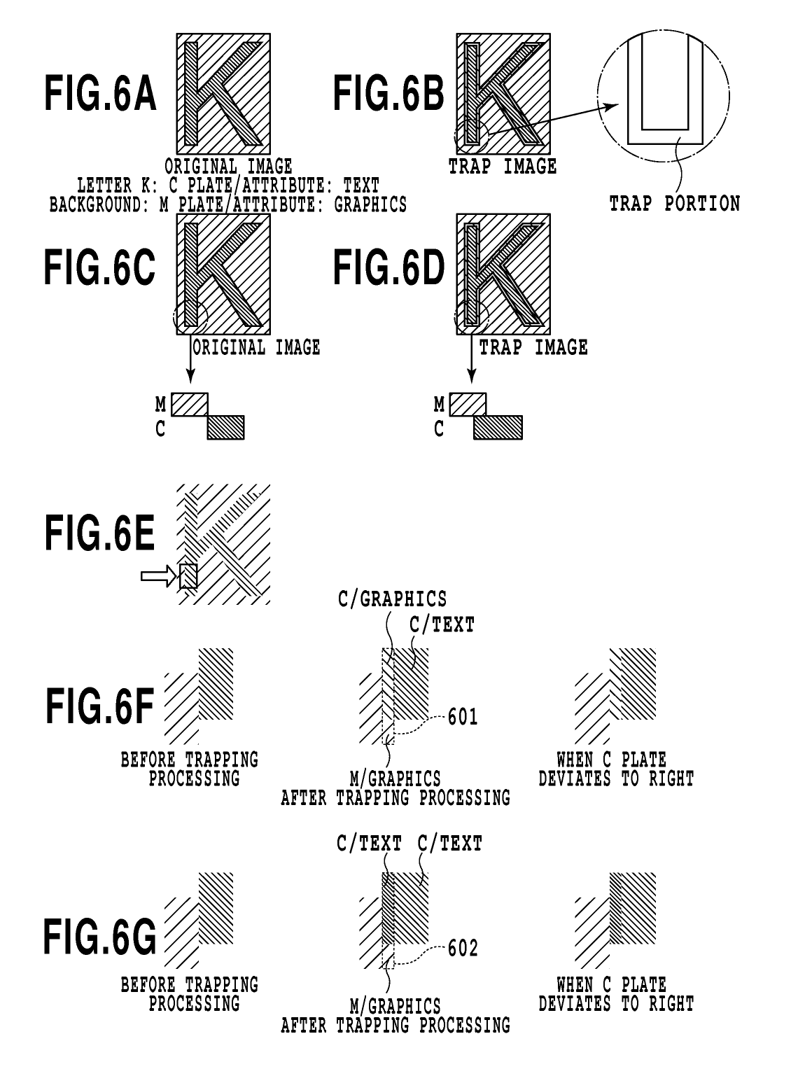

More specifically, as for the attribute in the trap portion 602 after the trapping processing of FIG. 6G when the text portion cyan plate of FIG. 6A traps the background magenta plate, the text attribute is assigned to the cyan plate, and the graphics attribute is assigned to the magenta plate.

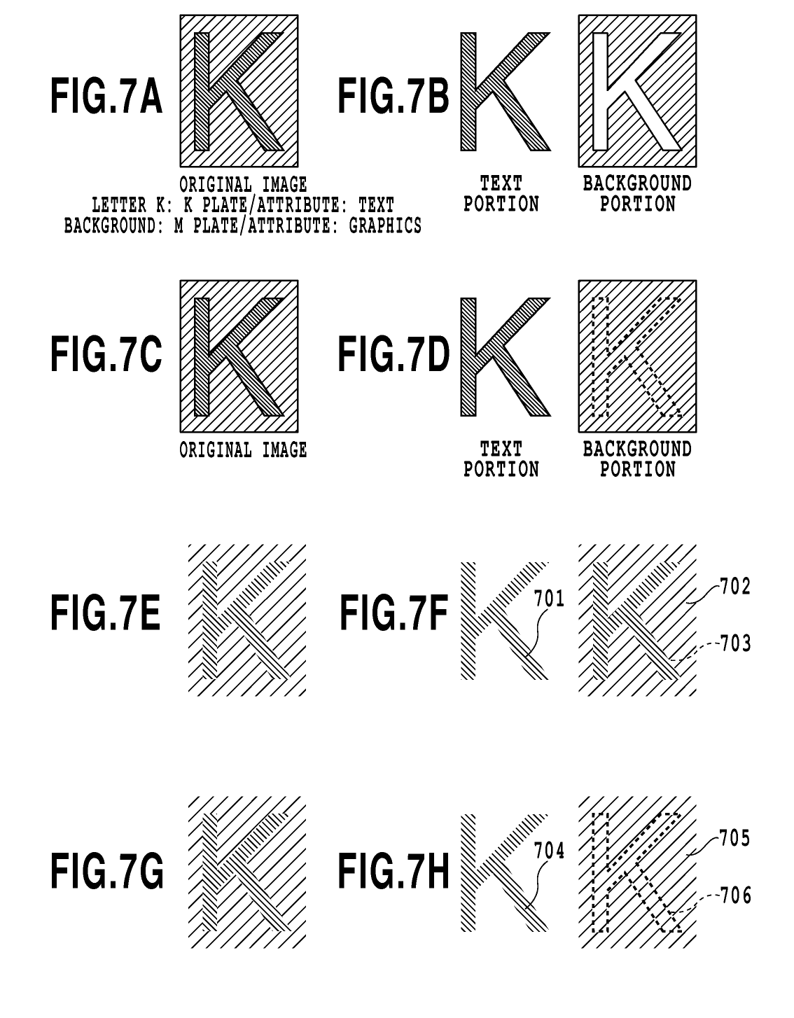

On the other hand, the black overprint processing becomes as follows when the black (K) plate of FIG. 7A has the text attribute (701) and the magenta plate has the graphics attribute (702). More specifically, the black plate of FIG. 7H has the text attribute (704); and although the magenta plate has the graphics attribute (705) in the background portion, it has also the graphics attribute (706) in the text portion.

Subsequently, using the attribute information and image information for each plate, the image processing section 308_1 carries out the gamma correction processing and dithering processing. Here, although the attribute information about the above-mentioned trap portion or overprint portion differs for each plate, referring to the attribute information for each plate, the image processing section 308_1 carries out desired gamma correction processing and dithering processing.

The foregoing processing can improve the image quality remarkably. In the case where the pixels at the same positions have the same attribute for all the plates, and when the trapping processing as indicated by the term “after trapping processing” in FIG. 6F is carried out, the cyan plate has the graphics attribute in the trap portion that is subjected to the trapping processing as well. As a result, the image processing section 408 cannot process the trap portion by the dithering for text as the text portion expanded by the trapping processing. Thus, the dithering processing in the image processing section 408 performs the dithering different from the proper one (that is, the dithering for graphics) on the trap portion, thereby deteriorating the appearance.

On the other hand, the processing of the present example can maintain the attribute for each plate. Accordingly, as indicated by the term “after the trapping processing” in FIG. 6G, the cyan plate that has been subjected to the trapping processing can maintain the same attribute even at the trap portion. Thus, the dithering processing in the image processing section 308_1 can cover the trap portion with the same dithering (dithering for text), thereby being able to prevent the image degradation as in the conventional case.

### Second Example

Next, as a second example of the present embodiment, a case will be described in which the image transforming processing in the image transforming processing section 103_3′ is carried out in the aspect of the image transforming processing section 201_1 as shown in FIG. 2A. In this case, the processing in the image transforming processing section 103_3 is not performed.

As shown in FIG. 3B, a communication interface (communication I/F) 301_2 receives a command group, first. The received command group is sent to an interpreter 302_2, which interprets it and converts to the intermediate code. Subsequently, the attribute information for each pixel is developed from the attribute information contained in the command group. After that, an attribute plate dividing processing section 303_2′ divides the attribute information to each plate, and using the attribute information, an image transforming processing section 303_2′″ performs the transforming processing of a specific object for each plate.

According to the result of the image transforming processing, an attribute rewriting processing section 303_2″ carries out the attribute rewriting processing. After that, the intermediate code is converted into bitmaps of the plates corresponding to a plurality of color materials. Finally, the image processing section 308_2 performs various image processing based on the attribute information.

### Third Example

Next, as a third example of the present embodiment, a case will be described in which the image transforming processing in the image transforming processing section 103_3 is carried out in the aspect of the image transforming processing section 201′ as shown in FIG. 2B. In this case, the processing of the image transforming processing section 103_3′ is not carried out.

As shown in FIG. 3C, a communication interface (communication I/F) 301_3 receives a command group, first. The received command group is sent to an interpreter 302_3, which interprets it and converts to the intermediate code. In addition, a Rip 303_3 converts the intermediate code into bitmaps of the plates corresponding to a plurality of color materials. In this case, from the attribute information contained in the command group, the attribute information for each pixel is developed.

Subsequently, in accordance with the attribute information, the image transforming processing section 305_3 executes the processing of transforming the object for each plate. Then, according to the result of the transforming processing, an attribute generating processing section 306_3 generates attribute information for each plate (retouches the foregoing attribute information and divides it to each plate). Finally, referring to the attribute information generated for each plate, the image processing section 308_3 executes various image processing such as dithering processing.

### Fourth Example

Next, as a fourth example of the present embodiment, a case will be described in which the image transforming processing in the image transforming processing section 103_3′ is carried out in the aspect of the image transforming processing section 201_1′ as shown in FIG. 2B. In this case, the processing of the image transforming processing section 103_3 is not carried out.

As shown in FIG. 3D, a communication interface 301_4 receives a command group, first. The received command group is sent to an interpreter 302_4, which interprets it and converts to the intermediate code. In addition, a Rip 303_4 converts the intermediate code into bitmaps of the plates corresponding to a plurality of color materials. In this case, from the attribute information contained in the command group, the attribute information for each pixel is developed.

Subsequently, in accordance with the attribute information, an image transforming processing section 303_4″ executes the processing of transforming the object for each plate. Then, according to the result of the transforming processing, an attribute generating processing section 303_4′ generates attribute information for each plate (retouches the foregoing attribute information and divides it to each plate). Finally, referring to the attribute information generated for each plate, an image processing section 308_4 executes various image processing such as dithering processing.

In the foregoing first to fourth examples, the attribute information is divided to all the plates corresponding to the color materials. In the following, an embodiment will be described which can reduce the amount of memory to be used by limiting the plate division of the attribute information to only plates having significant effect on the result of the image transforming processing.

### Second Embodiment

When limiting the image transforming processing in the image transforming processing section 305 of FIG. 3A to the trapping processing or black overprint processing, the following configuration is conceivable for reducing the memory for attribute information.

More specifically, in the attribute plate dividing processing in the first example of the first embodiment, such attribute information is not generated or provided as the attribute information about the yellow plate in which screen lines are hardly visible in the output of the printer 309, or the attribute information about the black plate not required in the trapping processing or black overprint processing. Thus, the memory for the attribute information is reduced.

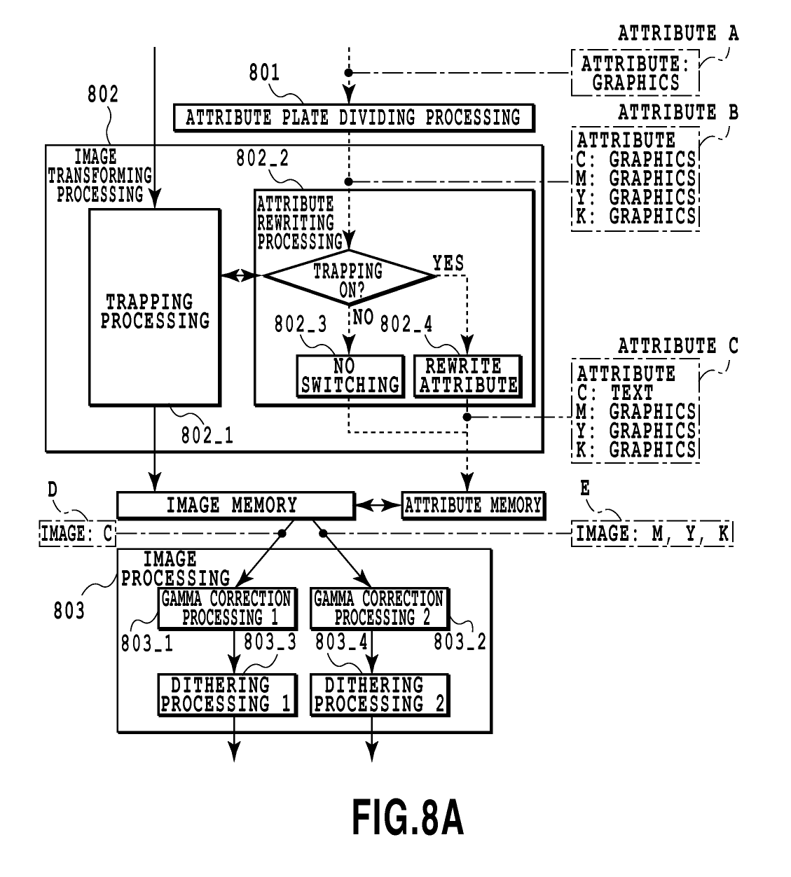

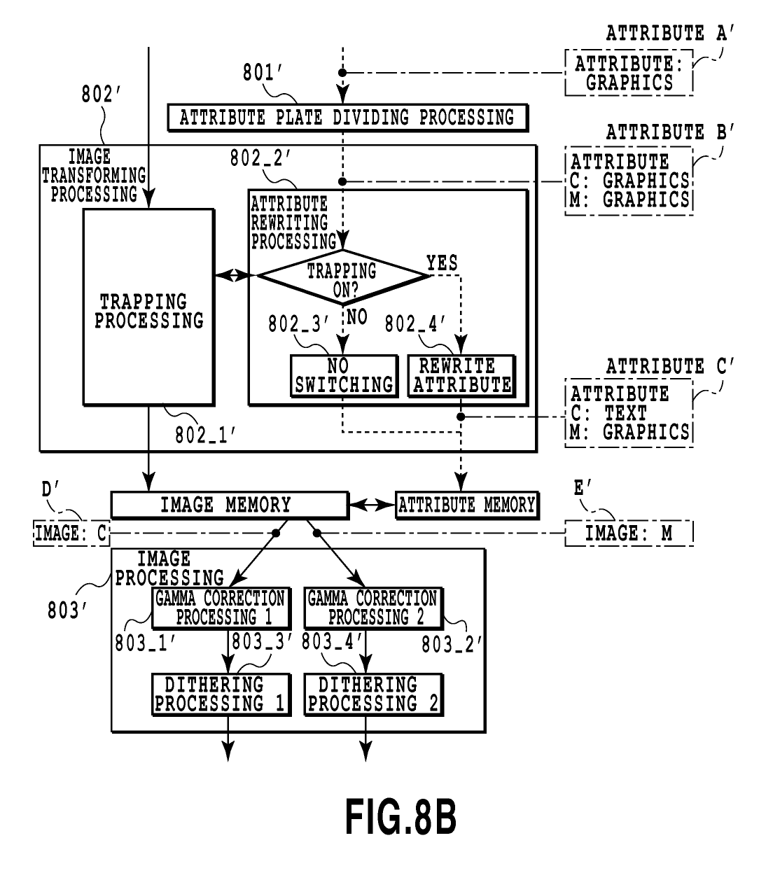

More specifically, in attribute plate dividing processing 801 as shown in FIG. 8A, an attribute A is normally divided into respective plates to form an attribute B. In addition, a portion subjected to the trapping processing (i.e. trap portion) by the trapping processing 802_1 in the image transforming processing 802 comes to have an attribute C by attribute rewriting processing 802_2. Then, according to the attribute information, image processing 803 performs the gamma processing or dithering processing for each plate. Although FIG. 8A shows exemplarily two types of the gamma processing and dithering processing, the gamma processing or dithering processing corresponding to attributes is prepared for the number of the attributes.

Here, the cyan plate having the text attribute undergoes the gamma correction processing 1 (803_1) for the text attribute, followed by the dithering processing 1 (803_3) for the text attribute. On the other hand, the magenta, yellow and black plates having the graphics attribute undergo the gamma correction processing 2 (803_2) for the graphics attribute, followed by the dithering processing 2 (803_4) for the graphics attribute.

The method of reducing the memory for the attribute information is as follows.

First, as shown in FIG. 8B, in attribute plate dividing processing 801′, an attribute A′ is divided into only cyan plate and magenta plate to form an attribute B′. In addition, a portion, which has been subjected to the trapping processing by trapping processing 802_1′ in image transforming processing 802′, comes to have an attribute C′ by the attribute rewriting processing 802_2′. Then, image processing 803′ performs the gamma processing and dithering processing for each plate in accordance with the attribute information.

The cyan plate having the text attribute undergoes the gamma processing 1 (803_1′) for the text attribute, followed by the dithering processing 1 (803_3′) for the text attribute. On the other hand, the remaining plates having the graphics attribute undergo the gamma processing 2 (803_2′) for the graphics attribute and the dithering processing 2 (803_4′) for the graphics attribute.

Finally, an embodiment will be described in which both the image transforming processing section 103_3 and image transforming processing section 103_3′ operate in accordance with the type of the attribute.

### Third Embodiment

Here, a configuration will be described which provides a user who wishes to perform detailed settings with the trapping processing in the Rip, and a user who wishes to perform the trapping processing quickly with the trapping processing using hardware after the Rip.

When the user designates the trapping processing in the Rip, the trapping processing after the Rip must be turned off normally. To achieve this, “information as to whether the trapping processing in the Rip has been performed or not” must be delivered after the processing by the Rip, and to transfer the information, a memory is required. However, since the portion subjected to trapping processing has the attribute information different for each plate at the same pixel, a decision can be made, when carrying out the trapping processing after the processing by the Rip, as to whether the trapping processing has been performed or not in the Rip by checking whether the attribute differs or not for each plate.

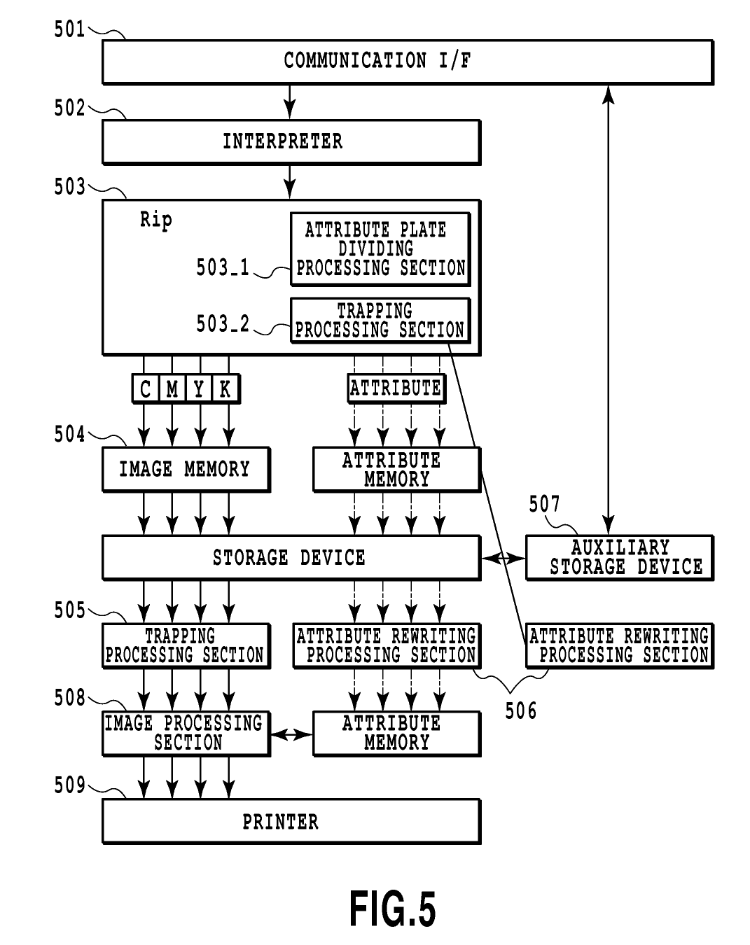

From the foregoing, the configuration as shown in FIG. 5 is possible. Here, the trapping processing in the Rip is performed on a boundary between the text and graphics or on an object with a gradation. In the other portions in which misregistration is likely to occur, the trapping after the processing by the Rip is performed. More specifically, an attribute plate dividing processing section 503_1 in the Rip of FIG. 5 generates the attribute information for each plate at first. Subsequently, using the attribute information, a trapping processing section 503_2 in the Rip executes the trapping processing. After that, an attribute rewriting processing section 506 performs the attribute rewriting processing.

A trapping processing section 505 performs the trapping processing after the processing by the Rip. Here, it carries out the trapping processing at the boundary of an object that enables the trapping processing and at the time when the attribute information of the same pixels is constant regardless of the plate. In this case, the attribute rewriting processing section 506 further performs the attribute rewriting processing, followed by image processing 508.

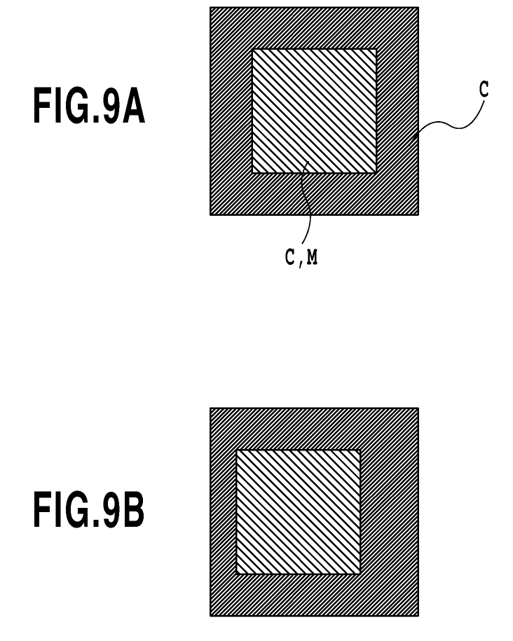

Incidentally, as for the trapping processing described in all the foregoing embodiments, when plates with the same attribute are present as shown in FIG. 9A, the trapping processing is not performed even at the boundary of the object because no white portion is left in such a case. For example, even if the magenta plate deviates as shown in FIG. 9B, the trapping processing is not necessary, because the cyan object appears from under the magenta plate. Accordingly, two or more attributes are never generated for the same plate and for the same object.

The foregoing is the description of the image transforming processing and the attribute plate dividing processing (or attribute generating processing) in the case where the PDL image data received by the image receiving section 102 is processed by the printer image processing section 103_2, image transforming processing section 103_3, and remaining image processing section 103_4. The following is the description of the image transforming processing and attribute generating processing in the case where the image data read by the image reading section 101 is processed by the scanner image processing section 103_1, image transforming processing section 103_3, and remaining image processing section 103_4 as a fourth embodiment in accordance with the present invention.

### Fourth Embodiment

The fourth embodiment will be described with reference to FIG. 1.

First, the image reading section 101 reads an original document and supplies color image data to the scanner image processing section 103_1. According to the received color image data, the scanner image processing section 103_1 generates flag data indicating a feature of the image for each pixel. The flag data is data designating a text-thin line, color, or halftone dot (a text-thin line flag, color flag, or halftone dot flag) which is an attribute of a target pixel. The feature of the image indicating such an attribute, which is identified by the changes of the image data, can be identified using a well-known technique. For example, the text-thin line can be identified from a pattern of an edge detected on the image. The scanner image processing section 103_1 further divides the flag data for each of color plates corresponding to a plurality of color materials.

Subsequently, in accordance with the flag data, the image transforming processing section 103_3 transforms, for each color plate, a specific characteristic area of the image considered to be an object on the image. Subsequently, in accordance with the result of the transforming processing, the image transforming processing section 103_3 rewrites the flag data for each color plate in the same manner as to rewrite the attribute information in each foregoing embodiment. Then, the remaining image processing section 103_4 performs various image processing using the rewritten flag data.

### Other Embodiments

The individual embodiments are described in detail above. The present invention, however, can be implemented as an embodiment of a system, apparatus, method, program or computer readable storage medium (recording medium), for example. More specifically, the present invention is applicable to a system comprising a plurality of devices, or to an apparatus comprising a single device.

A software program (program corresponding to the flow of the processing shown in the drawing in each embodiment) for implementing the functions of the foregoing embodiments can be supplied to a system or apparatus directly or remotely as is well known. Accordingly, the present invention can be implemented by causing the computer of the system or apparatus to read the program code supplied and to execute it.

Thus, the program code itself installed in a computer to implement the functional processing of the present invention by the computer is also a device that implements the present invention. In other words, the present invention includes a computer program itself for implementing the functional processing in accordance with the present invention.

In this case, as long as it possesses the function of the program, it can be any form such as object code, a program executed by an interpreter, and script data to be supplied to an OS.

As a recording medium for supplying the program, there are floppy disks, hard disks, magnetic tapes, and involatile memory cards, for example. In addition, there are optical disks or magneto-optical disks such as MO, CD-ROM, CD-R, CD-RW, ROM, DVD (DVD-ROM and DVD-R).

In addition, as a providing method of the program, it is possible to connect to a Web site of the Internet using a browser of a client computer, and to download the computer program of the present invention from the Web site to a recording medium like a hard disk. The program to be provided can be compressed and provided as a file containing an automatic installation function. Furthermore, it is also possible to divide the program code constituting the program of the present invention to a plurality of files, and to download the individual files from different Web sites. Thus, the present invention also includes a WWW server or servers that allow a plurality of users to download to computers the program file or files for implementing the functional processing of the present invention.

It is also possible to encrypt the program of the present invention to store in storage mediums like CD-ROMs, and to distribute to users. In this case, it is also possible to implement by causing a user who satisfies prescribed conditions to download the key information for deciphering the encryption from a Web site via the Internet, and by executing the encrypted program using the key information to install in the computer.

In addition, the functions of the foregoing embodiments can be implemented by causing a computer to execute the program read out. As for the execution of the program, an OS operating on the computer or the like, according to the instructions of the program, can perform part or all of the actual processing.

Furthermore, the functions of the foregoing embodiments can also be implemented by a function expansion board inserted into a computer or by a function expansion unit connected to the computer. In this case, the program read from the recording medium is written into a memory on the function expansion board inserted into the computer or a memory in the function expansion unit connected to the computer, first. After that, according to the instructions of the program, the CPU on the function expansion board or in the function expansion unit executes part or all of the actual processing, thereby implementing the functions of the foregoing embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-101616, filed Apr. 9, 2007 which is hereby incorporated by reference herein in its entirety.

What is claimed is:

1. An image processing apparatus comprising:
input means for inputting image data represented in a command group associated with each object constituting an image;
interpreting means for interpreting the command group to convert into intermediate code;
attribute plate dividing means for dividing attribute information contained in the command group for each of specified color plates of color plates corresponding to a plurality of color materials;
means for bitmapping the intermediate code for each color plate;
image transforming means for transforming, in accordance with the attribute information, an area of a bitmapped specific object for each color plate;
attribute rewriting means for rewriting an attribute in the attribute information according to a result of transforming processing by said image transforming means; and
image processing means for executing image processing using the rewritten attribute information.

2. The image processing apparatus as claimed in claim 1, wherein the attribute information contains information designating an attribute of the object, which includes a graphics attribute, a color attribute, a natural image attribute, a text attribute, and a thin line attribute.

3. The image processing apparatus as claimed in claim 1, wherein said image transforming means executes black overprint processing or trapping processing.

4. The image processing apparatus as claimed in claim 1, wherein said image processing means executes the image processing corresponding to the attribute information different for each color plate in color processing or dithering processing executed after processing by said image transforming means.

5. The image processing apparatus as claimed in claim 1, wherein said attribute plate dividing means divides the attribute information only about a plate having significant effect on a result of the image transforming processing.

6. An image processing apparatus comprising:
input means for inputting image data represented in a command group associated with each object constituting an image;
interpreting means for interpreting the command group to convert into intermediate code;
attribute plate dividing means for dividing attribute information contained in the command group for each of specified color plates of color plates corresponding to a plurality of color materials;
image transforming means for transforming, in accordance with the attribute information, an area of a specific object in the intermediate code for each color plate;
attribute rewriting means for rewriting an attribute in the attribute information according to a result of transforming processing by said image transforming means;
means for bitmapping the intermediate code for each color plate; and
image processing means for executing image processing in accordance with the attribute information of each color plate.

7. The image processing apparatus as claimed in claim 6, wherein the attribute information contains information designating an attribute of the object, which includes a graphics attribute, a color attribute, a natural image attribute, a text attribute, and a thin line attribute.

8. The image processing apparatus as claimed in claim 6, wherein said image transforming means executes black overprint processing or trapping processing.

9. The image processing apparatus as claimed in claim 6, wherein said image processing means executes the image processing corresponding to the attribute information different for each color plate in color processing or dithering processing executed after processing by said image transforming means.

10. The image processing apparatus as claimed in claim 6, wherein said attribute plate dividing means divides the attribute information only about a plate having significant effect on a result of the image transforming processing.

11. An image processing apparatus comprising:
input means for inputting image data represented in a command group associated with each object constituting an image;
interpreting means for interpreting the command group to perform bitmapping for each of color plates corresponding to a plurality of color materials;
attribute information generating means for developing attribute information contained in the command group;
image transforming means for transforming for each color plate an area of a bitmapped object in accordance with the attribute information;
attribute generating means for generating the attribute information for each specified color plate according to a result of transforming processing by said image transforming means; and
image processing means for executing image processing in accordance with the attribute information of each color plate.

12. The image processing apparatus as claimed in claim 11, wherein the attribute information contains information designating an attribute of the object, which includes a graphics attribute, a color attribute, a natural image attribute, a text attribute, and a thin line attribute.

13. The image processing apparatus as claimed in claim 11, wherein said image transforming means executes black overprint processing or trapping processing.

14. The image processing apparatus as claimed in claim 11, wherein said image processing means executes the image processing corresponding to the attribute information different for each color plate in color processing or dithering processing executed after processing by said image transforming means.

15. The image processing apparatus as claimed in claim 11, wherein said attribute plate dividing means divides the attribute information only about a plate having significant effect on a result of the image transforming processing.

16. An image processing apparatus comprising:
input means for inputting image data represented in a command group associated with each object constituting an image;
interpreting means for interpreting the command group to convert into intermediate code;
attribute information generating means for developing attribute information contained in the command group;
image transforming means for transforming an area of a specific object in the intermediate code for each of color plates corresponding to a plurality of color materials;
attribute generating means for generating the attribute information of each color plate according to a result of transforming processing by said image transforming means;
means for bitmapping the intermediate code for each color plate; and
image processing means for executing image processing in accordance with the attribute information of each color plate.

17. The image processing apparatus as claimed in claim 16, wherein the attribute information contains information designating an attribute of the object, which includes a graphics attribute, a color attribute, a natural image attribute, a text attribute, and a thin line attribute.

18. The image processing apparatus as claimed in claim 16, wherein said image transforming means executes black overprint processing or trapping processing.

19. The image processing apparatus as claimed in claim 16, wherein said image processing means executes the image processing corresponding to the attribute information different for each color plate in color processing or dithering processing executed after processing by said image transforming means.

20. The image processing apparatus as claimed in claim 16, wherein said attribute plate dividing means divides the attribute information only about a plate having significant effect on a result of the image transforming processing.

21. An image processing apparatus comprising:
input means for inputting image data represented in a command group associated with each object constituting an image;
interpreting means for interpreting the command group to convert into intermediate code;
attribute plate dividing means for dividing attribute information contained in the command group for each of specified color plates of color plates corresponding to a plurality of color materials;
first image transforming means for transforming an area of a specific object in the intermediate code for each color plate in accordance with the attribute information;
first attribute rewriting means for rewriting the attribute information according to a result of transforming processing by said first image transforming means;
means for bitmapping the intermediate code for each color plate;
second image transforming means for identifying an area of an object without the transforming among the objects according to the attribute information of each color plate rewritten by said first attribute rewriting means, and for transforming for each color plate a portion requiring transformation in the area of the object identified;
second attribute rewriting means for further rewriting, according to a result of the transforming processing by said second image transforming means, the attribute information of each color plate rewritten by said first attribute rewriting means; and
image processing means for executing image processing according to the attribute information of each color plate rewritten by said second attribute rewriting means.

22. An image processing apparatus comprising:
reading means for reading an original document and outputting color image data;
generating means for generating flag data for indicating a feature of an image according to the color image data;
flag data plate dividing means for dividing the flag data for each of color plates corresponding to a plurality of color materials;
image transforming means for transforming for each color plate a specific characteristic area of the image according to the flag data;
flag data rewriting means for rewriting the flag data of each color plate according to a result of the transforming processing by said image transforming means; and
image processing means for executing image processing according to the rewritten flag data.

23. The image processing apparatus as claimed in claim 22, wherein the flag data consists of a text-thin line flag, a color flag, and a halftone dot flag.

24. The image processing apparatus as claimed in claim 22, wherein the feature of the image is identified by changes of the image data.

25. An image processing method comprising:
a step of inputting image data represented in a command group associated with each object constituting an image;
a step of interpreting the command group to convert into intermediate code;
a step of dividing attribute information contained in the command group for each of specified color plates of color plates corresponding to a plurality of color materials;
a step of bitmapping the intermediate code for each color plate;
a step of transforming, in accordance with the attribute information, an area of a bitmapped specific object for each color plate;
a step of rewriting an attribute in the attribute information according to a result of transforming processing by said step of transforming; and
a step of executing image processing using the rewritten attribute information.

26. An image processing method comprising:
a step of inputting image data represented in a command group associated with each object constituting an image;
a step of interpreting the command group to convert into intermediate code;
a step of dividing attribute information contained in the command group for each of specified color plates of color plates corresponding to a plurality of color materials;
a step of transforming, in accordance with the attribute information, an area of a specific object in the intermediate code for each color plate;
a step of rewriting an attribute in the attribute information according to a result of transforming processing by said step of transforming;
a step of bitmapping the intermediate code for each color plate; and
a step of executing image processing in accordance with the attribute information of each color plate.

27. An image processing method comprising:
a step of inputting image data represented in a command group associated with each object constituting an image;
a step of interpreting the command group to perform bitmapping for each of color plates corresponding to a plurality of color materials;
a step of developing attribute information contained in the command group;
a step of transforming for each color plate an area of a bitmapped object in accordance with the attribute information;
a step of generating the attribute information for each specified color plate according to a result of transforming processing by said step of transforming; and
a step of executing image processing in accordance with the attribute information of each color plate.

28. An image processing method comprising:
a step of inputting image data represented in a command group associated with each object constituting an image;
a step of interpreting the command group to convert into intermediate code;
a step of developing attribute information contained in the command group;
a step of transforming an area of a specific object in the intermediate code for each of color plates corresponding to a plurality of color materials;
a step of generating the attribute information of each color plate according to a result of transforming processing by said step of transforming;
a step of bitmapping the intermediate code for each color plate; and
a step of executing image processing in accordance with the attribute information of each color plate.

29. An image processing method comprising:
a step of inputting image data represented in a command group associated with each object constituting an image;
a step of interpreting the command group to convert into intermediate code;
a step of dividing attribute information contained in the command group for each of specified color plates of color plates corresponding to a plurality of color materials;
a first image transform step of transforming an area of a specific object in the intermediate code for each color plate in accordance with the attribute information;
a first attribute rewriting step of rewriting the attribute information according to a result of transforming processing by said first image transform step;
a step of bitmapping the intermediate code for each color plate;
a second image transform step of identifying an area of an object without the transforming among the objects according to the attribute information of each color plate rewritten by said first attribute rewriting step, and of transforming for each color plate a portion requiring transformation in the area of the object identified;
a second attribute rewriting step of further rewriting, according to a result of the transforming processing by said second image transform step, the attribute information of each color plate rewritten by said first attribute rewriting step;
an image processing step of executing image processing according to the attribute information of each color plate rewritten by said second attribute rewriting step.

30. An image processing method comprising:
a step of reading an original document and outputting color image data;
a step of generating flag data for indicating a feature of an image according to the color image data;
a step of dividing the flag data for each of color plates corresponding to a plurality of color materials;
a step of transforming for each color plate a specific characteristic area of the image according to the flag data;
a step of rewriting the flag data of each color plate according to a result of the transforming processing by said step of transforming; and
a step of executing image processing according to the rewritten flag data.
